(19) United States
(12) Patent Application Publication
(10) Pub. No.: US 2025/0170485 A1
(43) Pub. Date: May 29, 2025

(54) GAMING WITH EARPIECE 3D AUDIO

(71) Applicant: BRAGI GmbH, München (DE)

(72) Inventors: Maximilian Ilse, München (DE); Peter Vincent Boesen, München (DE)

(73) Assignee: BRAGI GmbH, München (DE)

(21) Appl. No.: 19/039,430

(22) Filed: Jan. 28, 2025

Related U.S. Application Data
(63) Continuation of application No. 18/491,434, filed on Oct. 20, 2023, now Pat. No. 12,226,696.
Application No. 18/491,434 is a continuation of application No. 17/737,516, filed on May 5, 2022, now Pat. No. 11,806,621.
Application No. 17/737,516 is a continuation of application No. 17/082,235, filed on Oct. 28, 2020, now Pat. No. 11,325,039.
Application No. 17/082,235 is a continuation of application No. 15/795,863, filed on Oct. 27, 2017, now Pat. No. 10,821,361.
(60) Provisional application No. 62/417,064, filed on Nov. 3, 2016.

(51) Int. Cl. A63F 13/54; A63F 13/211; A63F 13/215; A63F 13/217

(52) U.S. Cl. CPC A63F 13/54; A63F 13/215; A63F 13/211; A63F 13/217

(57) ABSTRACT

A method of providing an enhanced gaming experience includes steps of sensing environmental audio with at least one microphone of an earpiece, combining a game sound with the environmental audio to provide a composite audio signal, and transducing the composite audio signal at the earpiece. The game sound may be positioned within a three-dimensional audio environment. The composite audio signal may be transduced to provide a three-dimensional audio experience.

### RELATED APPLICATIONS

This application is a continuation of U.S. patent application Ser. No. 18/491,434 filed on Oct. 20, 2023 which is a continuation of U.S. patent application Ser. No. 17/737,516 filed on May 5, 2022 now patented as U.S. Pat. No. 11,806,621 which is a continuation of U.S. patent application Ser. No. 17/082,235 filed on Oct. 28, 2020 now patented as U.S. Pat. No. 11,325,039 which is a continuation of and claims priority to U.S. patent application Ser. No. 15/795,863 filed on Oct. 27, 2017 now patented as U.S. Pat. No. 10,821,361 which claims priority to U.S. Provisional Patent Application No. 62/417,064, filed on Nov. 3, 2016 and all entitled “Gaming with Earpiece 3D Audio”, hereby incorporated by reference in their entireties.

### FIELD OF THE INVENTION

The present invention relates to gaming. More particularly, but not exclusively, the present invention relates to enhanced gaming using wearable devices.

### BACKGROUND

One recent game that has enjoyed immense initial popularity has been POKEMON GO from Niantic, Inc. In normal operation a mobile device such as a phone is used which includes a camera. A user may observe video acquired by the phone by viewing the display of the phone. As a part of the gaming experience, an image may be inserted by the game in front of a video representation of an actual object.

What is needed are new and improved methods and systems for improving the gaming experience, especially those that improve the audio experience of the game.

### SUMMARY

Therefore, it is a primary object, feature, or advantage of the present invention to improve over the state of the art.

It is a further object, feature, or advantage of the present invention to improve gaming experiences.

It is a still further object, feature, or advantage of the present invention to improve gaming audio experiences.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a method of providing an enhanced gaming experience is provided. The method includes sensing environmental audio with at least one microphone of an earpiece, combining a game sound with the environmental audio to provide a composite audio signal, and transducing the composite audio signal at the earpiece. The game sound may be positioned within a three-dimensional audio environment. The composite audio signal may be transduced to provide a three-dimensional audio experience. The method may further include sensing user movement with at least one inertial sensor of the earpiece. The method may further include generating the game sound based on the user movement. The method may further include communicating the user movement to a computing device executing a game, determining a game sound based on the user movement from the computing device, and generating the game sound based on the user movement.

According to another aspect, a method of providing an enhanced gaming experience is provided. The method includes maintaining an augmented reality video environment associated with a camera and video display device, maintaining an augmented reality audio environment associated with a set of earpieces comprising microphones and speakers, and generating a gaming experience using the augmented reality video environment and the augmented reality audio environment. The set of earpieces may include one or more inertial sensors. The head position of a user may be sensed using the one or more inertial sensors. The augmented reality video environment may include game images and the augmented reality audio environment may include game sounds. At least a portion of the game images within the augmented reality video environment may have corresponding game sounds present in the augmented reality audio environment.

According to another aspect, a method of providing an enhanced gaming experience includes steps of determining a location of a user, sensing environmental audio with at least one microphone of at least one earpiece, selecting a game sound based on the location of the user, generating the game sound based on relative position between the location of the user and a perceived source location associated with the game sound. The method may further include transducing the game sound and the environmental audio at a speaker of the at least one earpiece. The method may further include selecting a game image based on the location of the user and displaying the game image to the user based on the location of the user.

### BRIEF DESCRIPTION OF THE DRAWINGS

FIG. 1 is a pictorial representation of an enhanced gaming experience using audio transparency in accordance with the illustrative embodiments.

FIG. 2 is a block diagram of audio transparency via the convergence of environmental and game audio as shown in the illustrative embodiments.

FIG. 3 is a flowchart depicting one embodiment of wireless earpiece components used to create a composite audio effect.

FIG. 4 is an illustrative example of the production of a composite audio effect via the user's wireless earpieces, a gaming system, and a scene in the user's surrounding environment.

FIG. 5 is a pictorial representation of wireless earpieces with sensors.

FIG. 6 is a pictorial representation of the wireless communication via the user, the earpieces worn by the user, a smartphone, and an electronic device in accordance with the illustrative embodiments.

FIG. 7 is a flowchart of the appearance of the imaging and three-dimensional audio effects to the user as the user moves in accordance with the illustrative embodiments.

FIG. 8 is a pictorial representation of an enhanced gaming system depicting the interaction between the user and the appearance of the game sound source as a smart phone tracks the user's location.

FIG. 9 is a pictorial representation of the interaction between the user's head movements, the inertial sensors of the earpieces, the gaming system, and the sounds heard by the user.

### DETAILED DESCRIPTION

The present invention relates to an enhanced gaming experience. Current gaming systems, such as POKÉMON GO, utilize a phone, a camera, and an image inserted in front of an object. In operation a mobile device such as a phone is used which includes a camera. A user may observe video acquired by the phone by viewing the display of the phone. As a part of the gaming experience, an image may be inserted by the game in front of a video representation of an actual object on the display of the mobile device. Thus, a user may, by viewing the display of the mobile device, see actual video imagery acquired with the camera as well as additional imagery added as a part of the game. Game imagery may be added based on the location of the user such as through using GPS location data. Thus, when a user is at a specific location they may be able to view specific game imagery which is mapped to that location.

According to one aspect, one or more ear pieces or headsets are used to enhance audio aspects of the gaming experience. The one or more earpieces or headsets may use an AUDIO TRANSPARENCY feature where ambient audio is sensed at one or more microphones of the earpiece and then reproduced at one or more speakers of the earpiece. Thus, even though a user may be wearing the earpiece or headset they are still able to hear ambient or environmental sound. In addition, game sounds may be added to the ambient or environmental sounds. The game sounds may be mapped to specific locations. Thus, when the user is at a specific location, they may hear a particular sound. In addition, sound processing may be performed based on the relative location of the user and the location of the source of the sound. Thus, for example, the sound may be heard when the user is at a set distance from the location of the source of the sound and the intensity of the sound may increase as the user approaches the location of the source of the sound. Similarly, 3D sound processing may be performed based on the relative location of the user (and both the right and left ears of the user) to the location of the source of the sound thus, for example, a user may hear the sound in a manner which provides them with spatial context as to where the source of the sound is located relative to their current position.

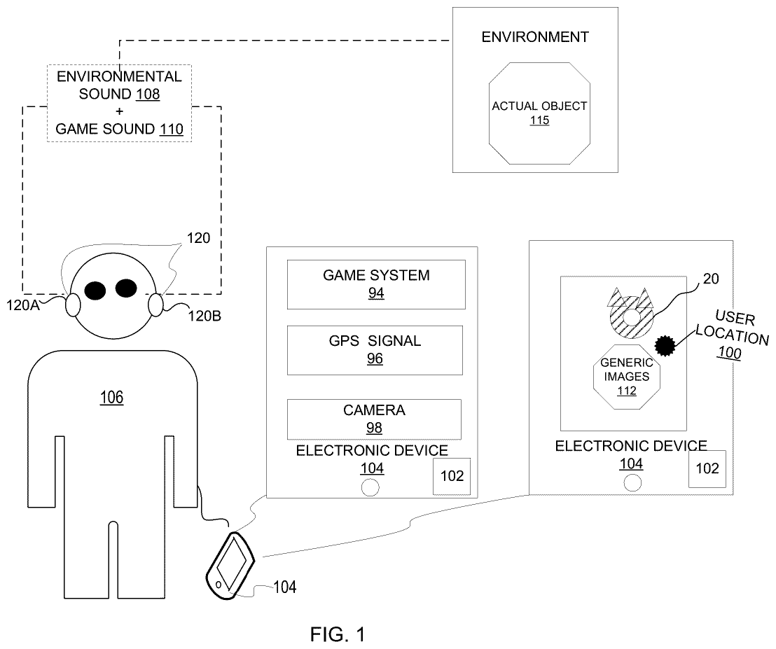

FIG. 1 displays a user 106 experiencing enhanced gaming with the audio transparency feature. The object image 20 on the phone 104 represents a clue or object in the game system 94. The phone 104 is not limited to a phone or smart phone, but may encompass other electronic devices, including but not limited to other mobile devices, iPADs, tablets, game consoles, etc. FIG. 1 displays two electronic devices intended to show the detail of two systems or two aspects of a system operating simultaneously within one device. The game system 94 may encompass all gaming applications or systems played on or incorporating any electronic devices. As the user 106 moves, the object image 20 on the phone 104 may move in response to updated position information received via a geospatial navigation system such as a global positioning (“GPS”) system receiver or other location tracking system. Of course, other types of navigation systems may be used. For example, a GLOSNASS position may be provided, a position may be interpolated based on nearby cell phone towers, a position may be determined based on one or more WiFi routers within range, a position may be determined based on a combination of one or more cell phone towers within range and one or more WiFi routers within range, the position may be determined based on sensing movement via one or more inertial sensors, or the position may be otherwise determined. The GPS signal 96 received at a GPS receiver of the phone 104 may be used to track the movement of the user 106. The game system 94 coordinates the user's movement as determined using the GPS signal 96 with the object image 20 on the phone. As the user 106 approaches a certain point, shown in FIG. 1 as the user location 100, the phone may vibrate or make a sound to alert the user 106. This sound is depicted in FIG. 1 as the game sound 110. Upon hearing the game sound 110, the user 106 has options, one of which is to continue the game by touching the screen of the electronic device 104 to activate the object image 20 or other generic images 112 in the game system 94. The user 106 may also approach a certain point and hear only the environmental sounds, as transmitted clearly from the wireless earpiece speakers to the internal microphone. Or, the user may reach a certain location and hear the game sounds overlapping with the environmental sounds. Actions of the user may vary depending on the particular gaming experience. In one embodiment of the enhanced gaming experience, a new sound would be inserted in front of the game sound 110. This new sound, depicted in FIG. 1 as environmental sound 108, would be framed by the position of the phone 104 and its sensors 102. This environmental sound 108 may come from the surrounding environment of the user 106, from the outside world, or it may be a sound generated by another electronic device such as a phone, an earpiece, or another external device. In one embodiment, the microphone of the earpiece(s) 120 senses the environmental sound 108 or the external sound.

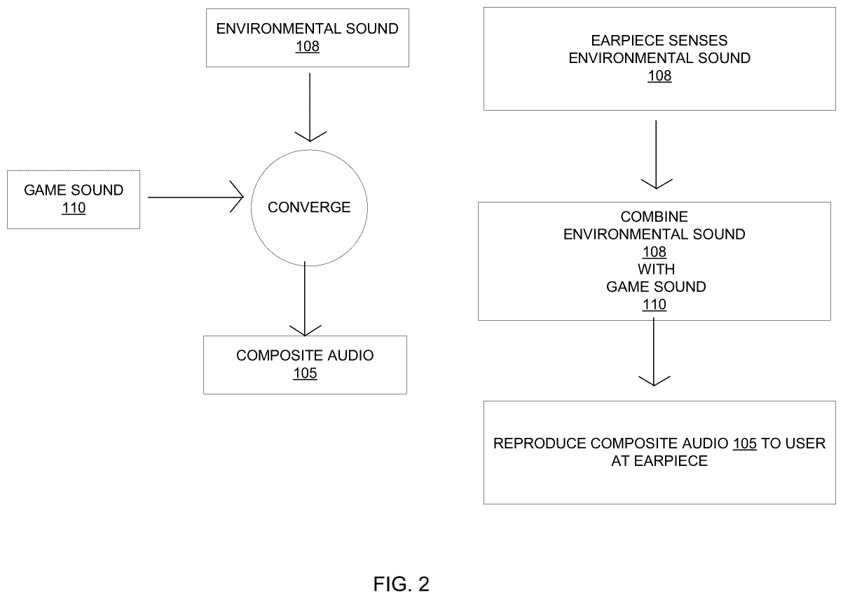

FIG. 2 displays an overview of the audio transparency technology. FIG. 2 depicts the convergence of the environmental sound 108 with the game sound 110 to form the composite audio 105. The wireless earpiece(s) 120, described in further detail later herein sense the environmental sound 108. The environmental sound 108 and the game sound 110 are combined, and the user 106 experiences the composite audio 105. This composite audio may be considered a feature of AUDIO TRANSPARENCY. The overlap of sounds extends to sounds from the game combined with sounds from other sources, such as other external devices or other users. Other earpiece users may participate in the game with the user, and the audio messages these users send may overlap with the game sounds or the environmental sounds in an ambient audio format. External speakers may transmit environmental sounds to the microphone of the user's earpieces. At the same time, the user may hear audio messages sent from other earpiece users. These audio messages may be restricted or require acceptance from the user before the message is relayed, depending on the user's earpiece settings.

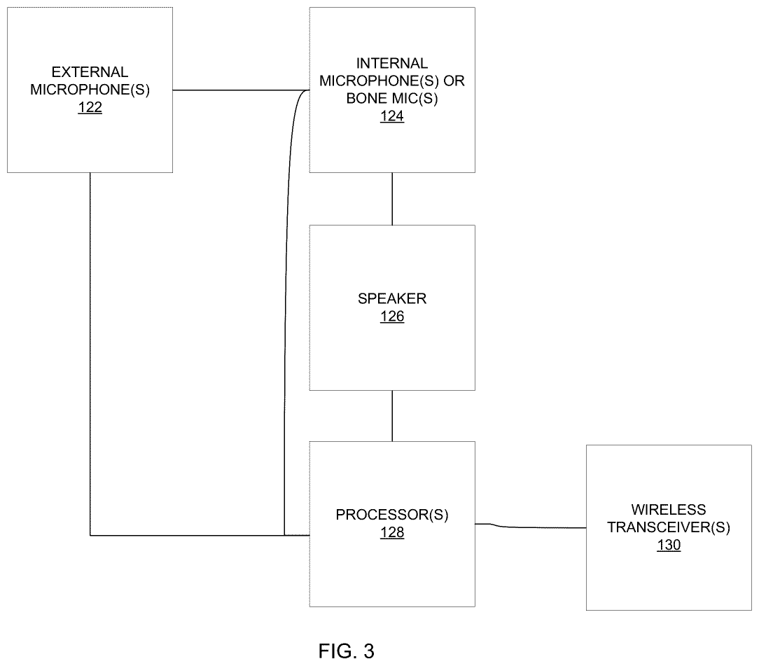

FIG. 3 is a flowchart depicting one use of the earpiece microphones to create the composite audio 105. In FIG. 3, the external microphones 122 of the earpiece(s) 120 may convey the environmental sounds 108 to the processor(s) 128, internal microphones 124, speaker 126, or the wireless transceivers 130. As the external microphone 122 conveys the environmental sound 108, the internal or bone microphone 124 may convey the game sound 110. As part of the audio transparency technology, the user 106 may experience game sounds 110 overlapped with environmental sounds 108. The composite audio may also be created as the wireless transceiver relays audio messages from other earpiece users, and the microphone conveys environmental sounds. Or the internal microphone of the wireless earpiece may convey sounds from other sources, such as music saved on an electronic device, or music streamed from a server, as the wireless transceiver conveys audio messages. The composite audio effect may also be created by layering the game sounds with music from another device and environmental sounds.

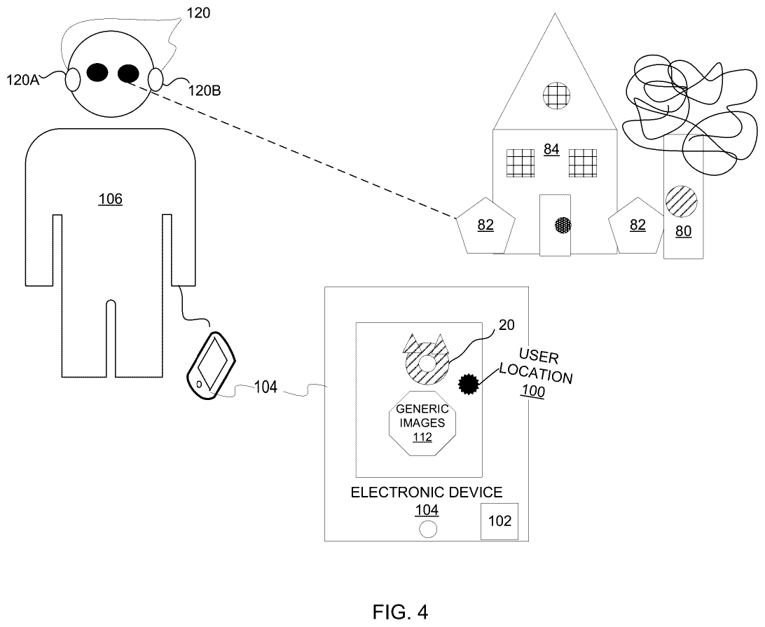

FIG. 4 depicts one non-limiting example of this audio transparency technology. FIG. 4 shows a user 106 looking at a house 84, a tree 80, and several bushes 82 in front of the house. The audio from the world (in this example, sounds from the house and surrounding foliage), would be transmitted normally to the earpiece or another device as the environmental sound 108. As the user discovers the clue or item being searched for, shown in FIG. 4 as the object image 20, the game alerts the user by introducing its own sound, the game sound 110, sonically positioned where the item would be able to be detected. No gaming experiences currently overlay game sounds with environmental sounds. One type of enhanced experience is created as game sounds 110 are interlaced with environmental sounds 108 transmitted using audio transparency technology which provides for sensing environmental sounds 108 using one or more earpieces 120 and then reproducing the environmental sounds 108 using one or more microphones of the earpiece. Although the example above describes outdoor sounds, environmental sounds may include all varieties of surrounding environments, including but not limited to: musical sounds, nightlife, churches, temples, and cathedrals, bells, airport sounds, fairground sounds, the sounds of sports games, travel sounds, the sounds of storms, environmental sounds from museums and libraries, birdsongs, animal calls, etc. Generic images 112 may also create game sounds different from those created by the object image 20, and these generic sounds may also be interlaced with the game sound 110 and the environmental sounds 108 to create another form of the composite audio sound 105. Generic images in the game may correspond with the environmental sounds. The images in the game may change according to the environmental sound the user is hearing. For example, if a user is near a cathedral, the GPS locator or the camera may capture this image. Then the earpiece may pick up the sound of the bell from the surrounding environment. Or, the earpiece may signal the user's electronic device or send a signal to a server to reproduce the sound of a bell. As the user hears the bell through the earpiece, a signal may be sent from the earpiece to the game to change the image on the phone to a cathedral (the image that corresponds to the sound of the bell).

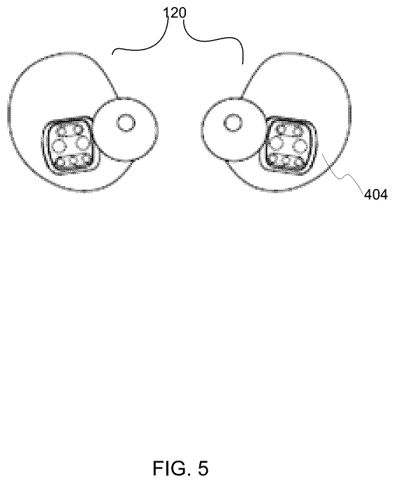

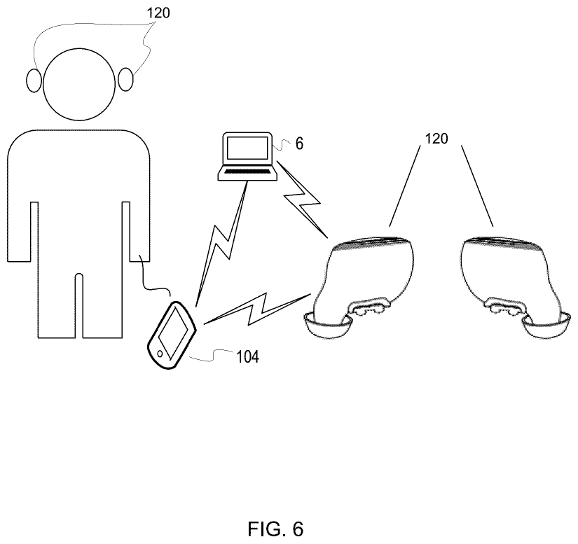

FIG. 5 displays the wireless earpieces 120, also labeled earpieces 120. FIG. 5 illustrates the earpiece sensors, which may include several different forms of sensors, to be used together or individually, including but not limited to inertial sensors, accelerometers, gyroscopes, photoelectric sensors, etc. The sensors may transmit different information to the earpieces, including but not limited to software instructions, data transmission, wireless intrabody communication, biomedical monitoring, etc. The sensors may track the heart rate, steps, or other bodily movements and activity of the user throughout the game. The sensors may be configured to work with the earpieces according to certain user preferences. For example, the sensors may be preset to work only when the user is playing the game. They may be preset to work only via galvanic communication, or only on battery power. The earpieces may transmit data from the sensors to the user via audio messages, or by sending messages to the user's electronic device. The earpieces may also transmit data from the sensors to smart glasses, where the user may read the data across the screen of the glasses. The earpieces may communicate with the sensor in different ways, depending on the configuration of the sensor. FIG. 6 displays a user 106 wearing the earpieces, and the earpieces communicating with a phone 104 and computer. Other electronic devices, though not included in FIG. 6, may communicate with the earpieces 120.

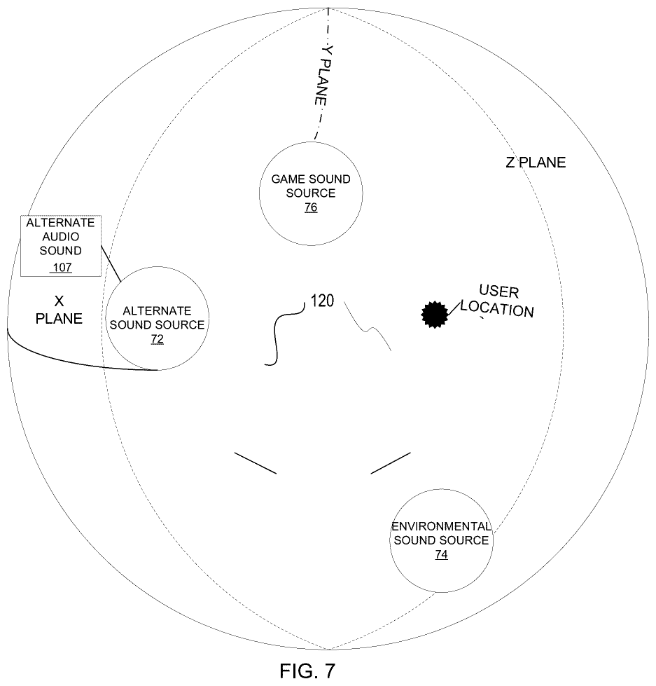

FIG. 7 shows another embodiment of an enhanced gaming experience, as the game sound 110 is positioned within a three-dimensional audio environment. FIG. 7 depicts the simulation of a three-dimensional audio environment. The earpieces 120, worn by the user 106 (not pictured), are surrounded by multiple sound sources. The embodiment is not limited to the three sources displayed in FIG. 7. The three sources occupy three different planes in space, displayed in the figure as the X, Y, and Z PLANES. The game sound 110 in the Y-plane appears to the user 106 to come from the game sound source 76. The environmental sound source 74 gives the illusion of the environmental sound 108 emanating from the Z-plane. And an alternate audio sound 107 appears to come from the alternate sound source 72 in the X-plane. By performing sound localization within the x, x-y or alternately the x-y-z planes, the user is provided with a more immersive experience. The audio signal is transduced to provide a three-dimensional audio experience for the user. The audio sounds appear to come from above, behind, and below the user. The effect of tricking the user's brain or simulating actual three-dimensional (“3D”) audio may be created with game sounds coming from the phone or another electronic device (iPAD, tablet, computer, etc.), in combination with sounds coming from the user's wearable earpieces, and from the actual outside environment, enhanced with the wireless earpieces. The effect may occur via speakers inside the earpieces which use head-related transfer function, HRTF filters, cross talk cancellation techniques, and other devices that mimic the appearance of sound waves emanating from a point in the user's three-dimensional space. FIG. 3 depicts one mechanism by which the wireless earpieces may be used to create this three-dimensional audio effect. The external microphone 122 brings in the noise of the outside world or the user's surroundings, creating an environmental sound 108. At the same time, the internal or bone microphones 124 may convey the game sound 110 and an alternate audio sound 107. A three-dimensional audio transparency effect is created as the game sound 110 is overlaid with the environmental sounds 110 and the alternate audio sound 107. If environmental sounds 108 are combined with game sounds 110, a two-dimensional audio effect can be created as well.

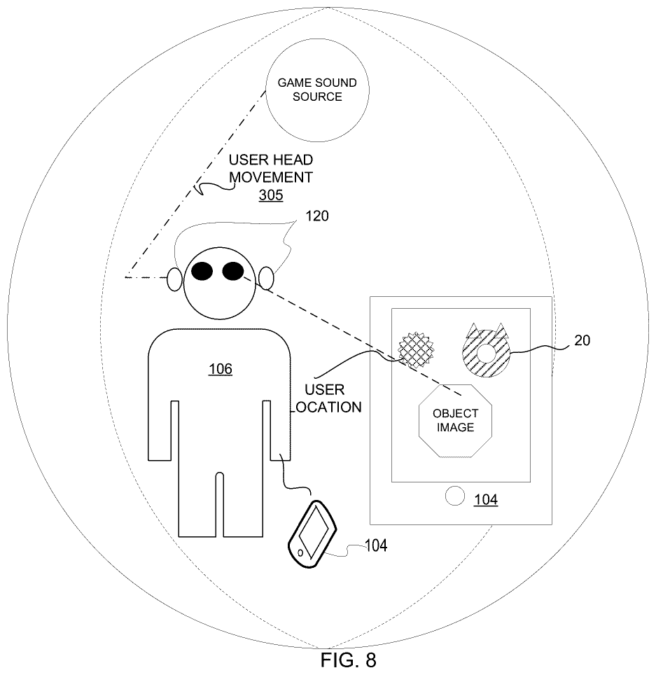

In another embodiment, shown in FIG. 8, the audio and imaging data streams are separated before they reach the user 106. This separation of audio and visual streams creates an augmented reality. The camera 98 of the phone 104 would be detached so that it could not immediately transfer information to the phone in conjunction with the audio system. For example, if the camera 98 was pointed toward the ground and the user was expecting a certain sound to emanate, the separation of audio and visual streams would allow the user to turn his/her/its head and pick up audio that would not necessarily be the same as that which would be detected by the camera-based phone position. The earpieces 120 may contain inertial sensors 404 to detect the user's head movements and generate a signal to emanate a certain sound. With the user's fixed point of reference created by disconnecting the camera, the earpieces allow the user, with a turn of the head (user head movement 305), to detect different audio streams from the point of view of the inertial sensors in the earpiece. The earpiece settings allow the user 106 to distinguish the camera-based outputs from the augmented audio reality which incorporates the audio transparency and sound features. This separation of audio and visual reality may also be created via smart glasses sharing data with the earpieces. The smart glasses may change the user's view of the game, or incorporate environmental images into the screen of the glasses. Overlapping the visual images in the game with images portrayed in the smart glasses may correspond with the overlap of audio effects between the earpieces, and the environment and game sounds. This overlap of visual and audio images created by the smart glasses and the wireless earpieces may create a different but enhanced gaming experience for the user.

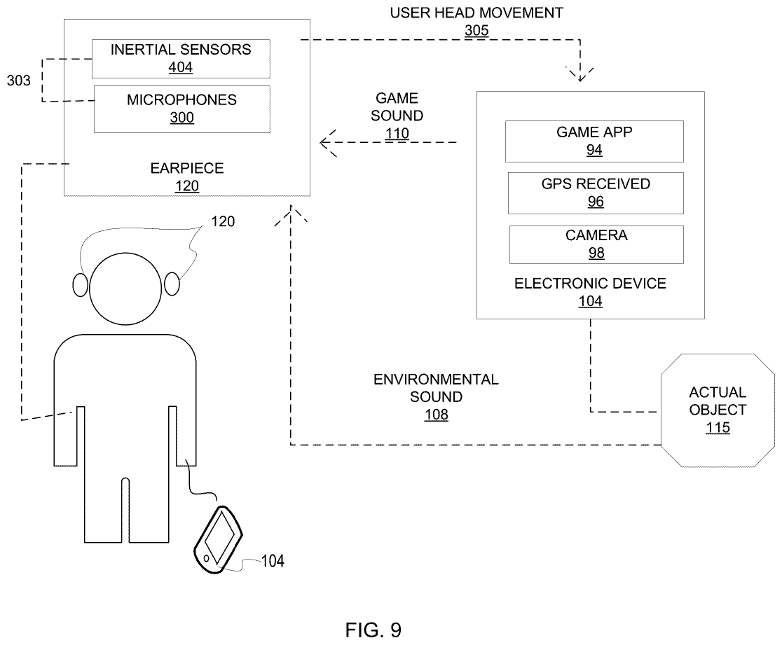

Another embodiment of the enhanced gaming experience, depicted in FIG. 9, utilizes inertial sensors which measure and report the movement of the user. Such sensors may indicate measurements including but not limited to the user's specific force, angular rate, magnetic field, etc. The inertial sensor(s) 404 may be located on the earpiece, or another wearable device of the user. As the inertial sensor 404 detects the user movement, the sensor may relay a signal to the phone to generate a game sound 110 based on the user movement. The inertial sensor 404 may also relay a signal 303 to the microphones 300 of the earpiece 120 or other wearable device to generate a sound. One or multiple inertial sensors 404 may be used to track the head position of a user (depicted in FIG. 10 as user head movement 305) and to generate a game or environmental sound based on the head position of the user. Examples of inertial sensors 404 include but are not limited to accelerometers, gyroscopes, magnetometers, etc. The inertial sensors may be used with the earpieces and the gaming system to create a unique gaming experience for the user. As the user moves his/her head, the inertial sensors may send signals to the wireless earpieces. The earpieces may generate sounds when the user's head is not turned toward the game. Or the earpieces may generate sounds as the user moves and controls the image within the game.

Therefore, various methods, systems, and apparatus have been shown and described. Although specific examples and embodiments are set forth herein it is to be understood that the present invention contemplates numerous variations, options, and alternatives.

What is claimed is:

1. A method of providing an enhanced experience to a user, the method comprising steps of:
mapping a sound source to a physical position using an electronic device;
determining a physical user location of the user using the electronic device;
sensing environmental audio with at least one microphone of an earpiece in operative communication with the electronic device;
generating a sound by the electronic device, the physical position mapped to the sound source, and the physical location of the user to provide spatial context as to where the sound source is located relative to the user within a three-dimensional audio environment;
combining the sound positioned within the three-dimensional audio environment with the environmental audio to provide a composite audio signal; and
transducing the composite audio signal at the earpiece to provide a three-dimensional audio experience.

2. The method of claim 1 further comprising sensing movement of the user with at least one inertial sensor of the earpiece.

3. The method of claim 2 wherein the generating the sound is based at least in part on the user movement.

4. The method of claim 1 further comprising tracking head position of the user using at least one inertial sensor.

5. The method of claim 4 wherein the generating the sound is based at least in part on the head position of the user.

6. The method of claim 1 further comprising acquiring digital imagery using a camera of the electronic device.

7. The method of claim 6 further comprising displaying the digital imagery on a display of the electronic device.

8. The method of claim 7 further comprising displaying generated imagery on the display of the electronic device.

9. The method of claim 8 wherein the digital imagery and the generated imagery are simultaneously displayed to provide an augmented reality video environment.

10. A method of providing an enhanced audio experience to a user, the method comprising steps of:
mapping a sound source to a physical position using an electronic device;
determining a physical user location of the user using the electronic device;
sensing environmental audio with at least one microphone of at least one wearable device;
generating a sound, the physical position mapped to the sound source, and the physical location of the user to provide spatial context as to where the sound source is located relative to the user within a three-dimensional audio environment;
combining the sound positioned within the three-dimensional audio environment with the environmental audio to provide a first composite audio signal and a second composite audio signal for a wearable device; and
transducing the first composite audio signal at a first speaker of the wearable device and the second composite audio signal at a second speaker of the wearable device to provide a three-dimensional audio experience.

11. The method of claim 10 further comprising sensing movement of the user with at least one inertial sensor of the wearable device.

12. The method of claim 11 wherein the generating the sound is based at least in part on the user movement.

13. The method of claim 10 further comprising tracking head position of the user using at least one inertial sensor of the wearable device.

14. The method of claim 13 wherein the generating the sound is based at least in part on the head position of the user.

15. The method of claim 10 wherein the wearable device comprises a first wireless earpiece and a second wireless earpiece.

16. The method of claim 10 wherein the wearable device is a headset.

17. A method of providing an enhanced audio experience, comprising:
maintaining an augmented reality video environment associated with a camera and video display device;
maintaining an augmented reality audio environment associated with a wearable device comprising microphones and speakers;
generating an experience using the augmented reality video environment and the augmented reality audio environment;
wherein the maintaining of the augmented reality audio environment is performed by:
mapping a sound source to a physical position,
determining a physical user location of the user,
sensing environmental audio with at least one microphone of the wearable device,
generating a sound, the physical position mapped to the sound source, and the physical location of the user to provide spatial context as to where the sound source is located relative to the user within a three-dimensional audio environment,
combining the sound positioned within the three-dimensional audio environment with the environmental audio to provide a composite audio signal,
transducing the composite audio signal at the wearable device to provide a three-dimensional audio experience for the augmented reality audio environment.

18. The method of claim 17 wherein the wearable device further includes one or more inertial sensors.

19. The method of claim 18 wherein head position of a user is sensed using the one or more inertial sensors and wherein the head position is used in maintaining the augmented reality audio environment.

20. The method of claim 17 wherein the augmented reality video environment includes generated images.
